(19) United States
(12) Patent Application Publication
(10) Pub. No.: US 2003/0039799 A1
(43) Pub. Date: Feb. 27, 2003

(54) Printing material with identification element

(75) Inventor: Wolfgang Eberhard Luxem, Kiel (DE)

Correspondence Address: Lawrence P. Kessler, Patent Department, NexPress Solutions LLC, 1447 St. Paul Street, Rochester, NY, 14653-7103, US

(73) Assignee: NextPress Solutions LLC

(21) Appl. No.: 10/208,321

(22) Filed: Jul. 30, 2002

(30) Foreign Application Priority Data
Aug. 22, 2001 (DE) 101 41 030.1

(51) Int. Cl. B32B 1/04

(52) U.S. Cl. 428/68

(57) ABSTRACT

A printing material is provided for control of a printing operation and for following the path of a printing material from manufacturing until recycling. The printing material is provided for a printing machine, whereby in the printing machine, data saved in the printing material is read and the read data is used in order to control the printing machine so that the settings of the printing machine are adapted to the printing material. The data is located in a thin elastic microchip, which is completely embedded in the printing material and does not impair the application of toner onto the surface of the printing material and the printing operation. The data of the microchip is read up to a distance of several meters in a non-contact manner.

### FIELD OF THE INVENTION

The invention involves a printing material, for a printing machine, such printing material having an identification element.

### BACKGROUND OF THE INVENTION

Digital printers are fed various printing materials from different containers. Because of small printing application quantities, frequent filling of the container with different printing materials is often necessary. When filling the container, errors sometimes occur, because the wrong printing material is filled and fed to the printing operation. In printing machines, a multitude of characteristics of the material to be printed on have to be set. The feeding of wrong printing material for any particular job leads to faulty printing and economic loss. For example, with the wrong printing material, mechanical malfunctions may occur, such as too strong pressing of the print cylinders onto the printing material; or printing may occur in the wrong format, where the printed image may be applied in a shifted manner relative to the printing material.

It is therefore highly desirable to prevent printing material filling errors in digital printing machines, and further to automate the feed sorting of the printing material. Moreover, in order to increase the speed and productivity of printing machines there is a need for monitoring and to a large extent automating the printing operation from the manufacture of the printing material until separation of different printing materials during the waste separation.

### SUMMARY OF THE INVENTION

The purpose of the invention is thus to prevent the above disadvantages, to simplify work operations in relation to the printing material and perform the printing operation in a safe and cost-effective manner. For this, a printing material for a printing machine is provided with an identification element on the printing material.

The identification element is used for the purpose of controlling the printing machine in such a way that the printing machine adapts the printing operation for the identified printing material. The error-free feed of printing material into the printing machine is ensured. Furthermore, the operating costs of the printing machine and the printing operation are reduced. In an advantageous variation, the path of the printing material can be tracked from manufacture to recycling. In this way, a multitude of work steps involving printing material identification and monitoring can be saved and simplified during the manufacture, loading, transport and waste separation of different printing materials.

In an especially advantageous manner, the identification element is a thin, elastic microchip, which is embedded into the printing material, so that the printing material can be used in the usual manner. The microchip is located in the printing material and does not impair the application of toner onto the surface of the printing material. Furthermore, an electronic writing device can be provided for writing data to the microchip. The microchip can, furthermore, contain a changeable memory into which, after the manufacturing operation of the printing material, with an identification element, data can be written in relation to a certain print job, whereby the printing material can be specified at the printing site for a specific print job. The identification element can contain patterns pressed into the printing material. With optical reading devices that are used in the ultraviolet spectral range, the pressed-in pattern on the printing material can be made so that it is finer than the resolution capacity of the human eye and is not visible. Advantageously, this saves additional elements and material.

The invention, and its objects and advantages, will become more apparent in the detailed description of the preferred embodiment presented below.

### BRIEF DESCRIPTION OF THE DRAWINGS

In the following, the invention is described in detail in relation to the drawings in which:

FIG. 1 is a side view of a cross-section of a sheet of printing material with an identification element for use in containers of a printing machine according to an embodiment form of the invention; and

FIG. 2 is a schematic diagram of a part of a feeder of a printing machine with an electronic reading device for reading the identification element of the printing material, according to this invention, and a control device of the printing machine.

### DETAILED DESCRIPTION OF THE INVENTION

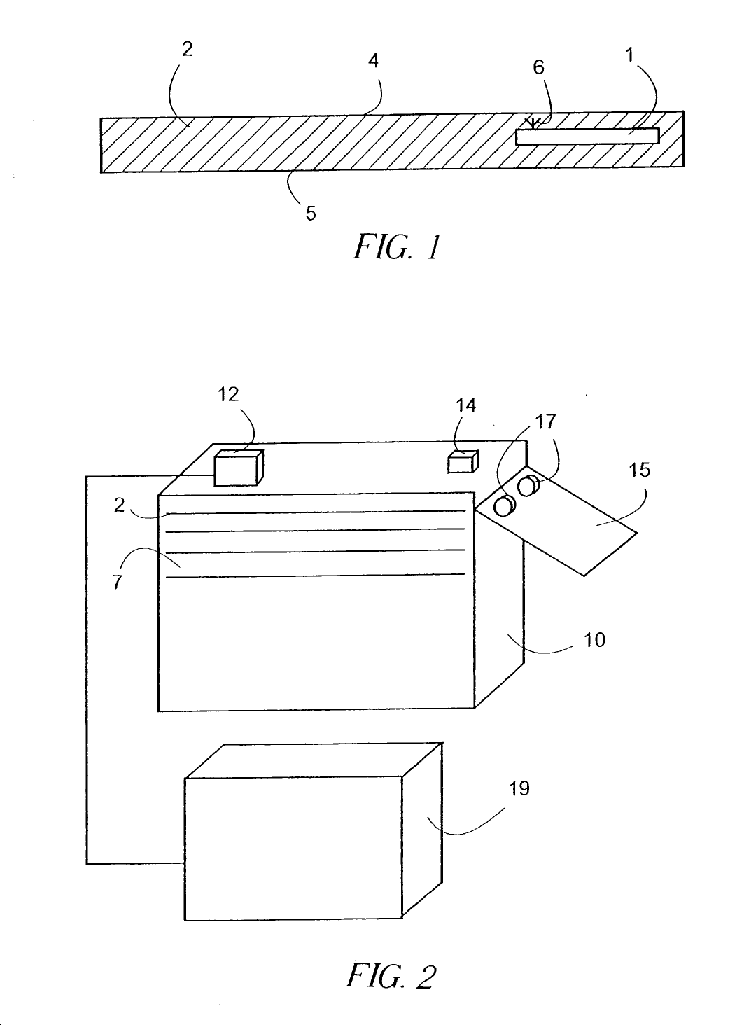

FIG. 1 shows a side view of a cross-section through a printing material 2, a sheet of paper for example, involving the invention. The printing material 2 is designed for printing on the first (obverse) print side 4 and on the second (reverse) print side 5 in a digital printing machine, for example in the (size) format DIN A3. An identification element 1 is located on the printing material 2, which in this example is surrounded on all of its sides by the printing material 2, but can likewise be applied on the surface of the printing material 2.

The identification element 1 is, for example, a microchip, which is extremely thin with a thickness of a few micrometers. In order to prevent damage to the microchip, it is constructed elastically and surrounded by a thin film. The thickness of the printing material 2 is not shown to scale in relation to the microchip in FIG. 1. Actually the thickness of the printing material 2 is a multiple of the thickness of the microchip for example, a thickness ratio of seven to one. The microchip cannot be seen from the outside of the printing material, and due to its low mass and elasticity does not impair the printing operation. Thus, the printing material 2 is flexible, without damaging the customary rigid microchips. The identification element 1 contains an electronic memory, in which data is saved which relates to the printing material 2. This data, for example, may include at least one of format, weight, color, surface, manufacturer of the printing material, or paper type.

FIG. 2 shows schematically a part of a feeder 10 of a printing machine with a tray 15, a suction device 14 for sucking sheets from a sheet stack 7 (depicted in FIG. 2 as horizontal lines) and rollers 17 for conveying sheets of the sheet stack 7 from the sheet stack. In the feeder 10, a reading device 12 for reading the identification element 1 is arranged. The feeder 10 contains several containers for the printing material 2, of which one container is depicted in FIG. 2. The sheet stack 7 may include different types of paper sheets for successive print jobs that are partially different. Different print jobs are performed with different printing materials 2 of the sheet stack 7. In this example, each stack of printing material 2 for a print job has one sheet of printing material 2 involving the invention, functionally the first sheet of each stack. For the printing material 2 in the feeder 10, accordingly, not every sheet is provided with an identification element 1.

The term print job identifies here a specific limited printing machine run for fulfilling a task, for example, manufacturing a brochure. The reading device 12, which is arranged above the sheet stack 7 at the feeder 10, reads the data from the identification element 1. The reading operation is non-contact, the microchip of the identification element 1 contains an antenna coil 6 as a transmitter and receiver and sends electric signals to the reading device 12. The data is transmitted by the reading device 12 to the control device 19 of the printing machine. In the control device 19, it is tested whether the sheets of the sheet stack 7 are suitable for the print job that is planned by the operator.

In the case that the sheets of the sheet stack 7 are not suitable for a particular print job, an appropriate message appears on the control device 19. In such a message, a warning is issued that an error is present, for example, that the operator of the printing machine inserted the wrong printing material 2 into the container of the feeder 10 for the current print job. To correct this, the sheet stack 7 is resorted, the print job is changed on the control device 19, or the printing machine is fed with suitable printing material 2 for the current print job from another container of the printing machine.

Printing material 2 with an identification element 1 according to FIG. 1 is provided for the first sheet of a print job, and the sheets of the sheet stack 7 following this one are made as usual. As an alternative, each sheet can be equipped with an identification element 1. If a suitable sheet is detected by the reading device 12, then the print job is performed, the sheets are lifted individually by a suction device 14 from the sheet stack 7 and conveyed using rollers 17 in the direction of the tray 15, from which the sheets are transported into the printing machine.

The reading device 12 detects the data relevant for the specific printing operation from the identification element 1, i.e. the printing material format, weight, color, surface, and/or paper type. Furthermore, using a writing device with a transmitter, data that relates to a certain print job for the printing material 2 can be transferred in a non-contact manner into the identification element 1 by the operator at the site of the printing, usually a printing office. This data can include the print run, the image content of the image to be printed and/or the information whether to print a first (obverse) print side or a second (reverse) print side. For this purpose, the identification element 1 contains a microchip with a changeable memory and a receiver.

The writing device for saving data in connection with a specific print job can be portable or constructed in the control device 19 of the print machine. By the portable nature of the writing device, print jobs on the printing machine are performed independently of data entries in the control device 19 of the printing machine, the print jobs are performed exclusively on the basis of the data in the identification element 1. It is to be mentioned that the data can also be transferred into the identification element 1, in relation to a certain print job, in the manufacturing process according to the data involving the printing material 2, and as a result, the saving of data using the writing device is not necessary.

The following scenario describes one preferred embodiment form of the invention. Using the writing device, the operator in the printing office transfers data, involving two print jobs, to the identification element 1 on the printing material 2. In the identification element 1, data is present as a result, which relates to the printing material 2 and is saved during the manufacturing operation of the printing material 2, and data which relates to the specific print job with this printing material 2 is saved by the operator of the corresponding printing machine using the writing device. As already described above, this data of a sheet of the printing material 2 is read by the reading device 12 in the printing machine and is available to the printing machine after it is transferred to the control device 19. From the information of the format of the sheet, the control device 19 generates control commands that change mechanical settings in the printing machine according to the format information, with the information about the weight, the conditioning temperature and the temperature on the fixing device are controlled. The color information controls possible color corrections of the print module during the printing operation, the surface information controls the press-on force of the print cylinder, and information about the paper type controls specific settings with regard to the paper type, i.e. the sheet forward feed.

The first print job is performed in reaction to the data read by the reading device 12, the printing machine does not require any additional control. From the information transferred by the operator via the writing device into the identification element 1 with regard to the print run, i.e. the number of the sheets to be printed for the first print job, the end of the print machine run is derived for the print job involved. After that, the reading device 12 detects a sheet of a different printing material 2 of the same or another container of the feeder 10 for a second print job, in which the data of the identification element 1 is transferred from a transmitter of the identification element 1 and received by the receiver of the reading device 12. The printing machine makes its adjustments, corresponding to the above description, for the second print job and performs the second print job. As in the first print job, also in the second print job, no additional control of the printing machine is required by the operator, the two print jobs are handled based on the data in the identification element 1.

The equipping of the printing material 2 with the identification element 1 has no influence on its printing characteristics since the identification element 1 in this example contains a microchip that is elastically flexible, does not hinder the paper run in the printing machine and is not damaged during printing and during the paper run in the printing machine. Also, in this case, the reading device 12 receives, among other things, the print run number of the second print job and transfers this information to the control device 19 of the printing machine, which controls the printing machine in such a way that the second print job ends with the last sheet of the sheet stack 7.

The sheet stack 7 with the printed sheets of the two print jobs is located in the out-feed at the other end of the printing machine after being printed with the finished printed image. The two print jobs are performed without the danger of a wrong allocation of printing material 2 to a specific print job and resultant error printings. The operator does not require any adjustment of print jobs at the control device 19 of the print machine, but instead using the writing device, transfers data to the identification element 1 with regard to certain print jobs or job-specific data. The writing device can be allocated to the printing machine and integrated into it or be an independent unit, for example, portable. The job-specific data can be further transferred together with the data involving the printing material 2 or printing material-specific data, as early as at the manufacturer, to the identification element 1, whereby the operator performs no controlling tasks on the printing machine, and printing operations are completely controlled by the data of the identification element 1.

Finally, an additional application of the invention is described. With the invention, not only is it possible to control a printing machine, but also through the saving of data on the printing material 2, the circulation of the printing material 2 can be monitored from its manufacture, shipping, transport, printing until the separation of different printing materials 2 during waste recycling. During the manufacture of the printing material 2, data is saved for this purpose on the printing material 2, which is read in a non-contact manner and which relates to the printing material 2 customer. In this way, the allocation of the printing material 2 to the customer is always provided for the manufacturer and for transport.

Reading devices 12 with display devices for reading the data of the printing material 2 can be, for example, mounted on a transport vehicle that transports the printing material 2 to the printing material customer and allows a control of whether the printing material 2 is loaded in the proper transport vehicle. The data can also be read, on account of the construction of the identification element 1 with a microchip and transponder, through the packaging material and over distances of several meters. At the printing material customer the saved data functions for the purpose of allocating the printing material 2 to the planned printing machine and then controlling the printing machine as described above.

After the printing, the saved data functions for the purpose of allocating the print product to the print product customer, just as in the allocation of the printing material 2 to the printing material customer at the manufacturer. The data involving the print product customer can be saved at the manufacturer of the printing material 2 or at the printing material customer. If, after consumption, the print product manufactured from the printing material 2 by the printing operation, for example, brochures, folding leaflets, or catalogs, is supplied to waste recycling, the data saved on the printing material 2 can be further used in order to separate different printing material types from each other and to recycle them in a targeted manner.

The state-of-the-art conveyor belts for waste separation have for this purpose at least one suitable reading device, which can detect the saved data even over large distances of the printing material 2 from the reading device. In the embodiment form described here with a microchip with an antenna coil as a transmitter and as a carrier of the data on the printing material 2, a distance of several meters of the printing material 2 from the reading device is possible. The printing materials 2 to be separated can thus be conveyed, as done until now, on a conveyor belt and, after reading and detecting the printing material-specific data, an automatic separation of the different printing materials 2 using the detected data can be performed and the different printing materials 2 can be supplied to recycling.

The invention has been described in detail with particular reference to certain preferred embodiments thereof, but it will be understood that variations and modifications can be effected within the spirit and scope of the invention.

What is claimed is:

1. Printing material (2) for a printing machine, characterized by an identification element (1) containing information whereby the path of the printing material (2) from the manufacturer to recycling can be tracked and controlled, and the printing operation on the printing material (2) can be controlled.

2. Printing material (2) according to claim 1, characterized in that said identification element (1) contains a storage device.

3. Printing material (2) according to claim 2, characterized in that said storage device contains a thin elastic microchip that is embedded in the printing material (2).

4. Printing material (2) according to claim 3, characterized in that said microchip contains a changeable memory, into which data can be written in relation to a specific print job after the manufacturing operation of the printing material (2).

5. Printing material (2) according to claim 4, characterized in that said storage device has a transmitter for transferring data of said storage device to a reading device (12) at the printing machine and/or manufacturing operation.

6. Printing material (2) according to claim 3, characterized in that the thickness of the identification element (1) with respect to the thickness of the printing material in the ratio of one to seven.
